(19) United States
(12) Patent Application Publication
(10) Pub. No.: US 2004/0220825 A1
(43) Pub. Date: Nov. 4, 2004

(54) Organizational restructuring

(76) Inventors: Sven Schwerin-Wenzel, Dielheim (DE); Nir Kol, Sunnyvale, CA (US); Eric Wood, Menlo Oaks, CA (US); Dennis B. Moore, Burlingame, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/750,229

(22) Filed: Dec. 31, 2003

Related U.S. Application Data
(60) Provisional application No. 60/455,087, filed on Mar. 14, 2003.

(51) Int. Cl. G06F 17/60

(52) U.S. Cl. 705/1

(57) ABSTRACT

A method includes providing a single logical physically distributed information system across one or more information systems of at least two enterprises, wherein the enterprises can be being combined, and providing a user interface to access the single logical information system, wherein the single logical physically distributed information system executes one or more merger activities, pre-merger activities, and post-merger activities, wherein the merger activities comprise organizational restructuring and personnel redeployment.

### CROSS REFERENCE TO RELATED APPLICATIONS

This application claims the benefit of priority from U.S. Provisional Application entitled “ENTERPRISE CHANGE PLANNING AND EXECUTION,” filed Mar. 14, 2003, Application Serial No. 60/455,087.

### FIELD OF THE INVENTION

The present invention relates to data processing by digital computer, and more particularly to an organizational restructuring system.

### BACKGROUND

During an organizational restructuring, such as a merger or acquisition, managers and human resource personnel can need to reassign employees to other groups, divisions, and departments in a merged organization. Managers and human resource personnel can also want to hire new candidates, or reduce their workforce through attrition. Sometimes, merger organizations can be overwhelmed with organizing and managing reorganizations of groups, departments, and individual employees. Moreover, the merger organizations can find it difficult to assuage concerns from employees while planning and keeping track of redeployments and assignments.

### SUMMARY

The present application describes systems, methods and software for enterprise change, such as mergers & acquisitions (M&As), for one or more organizations.

In an aspect, the invention features a method including providing a single logical physically distributed information system across one or more information systems of at least two enterprises, wherein the enterprises can be being combined, and providing a user interface to access the single logical information system, wherein the single logical physically distributed information system executes one or more merger activities, pre-merger activities, and post-merger activities, wherein the merger activities comprise organizational restructuring and personnel redeployment.

In embodiments, the user interface can be adapted to at least one of a role of the user and a phase of the merger, wherein the user role can include an internal expert and an external expert of one of the enterprises, wherein the internal expert can include at least one of an executive, an employee, a manager, an investor, and an owner of one of the enterprises, wherein the external expert can include at least one of a consultant, an advisor, a supplier, an analyst, and a specialist.

In another aspect, the invention features a system for planning a merger of at least two organizations, the system including a first interface adapted to allow a user to plan a human resource project related to the merger with a resource management capability and a time management capability, and a second interface adapted to deliver a targeted result related to the resource management capability and the time management capability wherein the second interface permits creating, posting, and sharing information related to the merger.

In embodiments, the system includes a user interface adapted for a manager of at least one of the organizations, further including tools adapted to allow a user to exchange merger information with a person associated with one of the organizations, wherein the person can be selected from a class consisting of managers, employees, customers, partners, suppliers, consultants, analysts and specialists.

In another aspect, the invention features a system for implementing a merger of at least two organizations, wherein the system can include a computer module adapted to allow a user to restructure at least one of the organizations, wherein the computer module can include instructions operable to perform at least one of a planning of an organizational movement of a person, a tracking of an organizational movement of a person, a tracking of an employee from various rankings and locations within at least one organization, an assigning of a person of one of the organizations to collaborate with a user of the system, a matching of organizational resources, and a redeploying of resources of at least one organization.

In embodiments, the tracking of an organizational movement of one or more employees can include a headcount and a measure of an influence of an organizational change on one or more employees in a time period. The computer module can generate one or more objects to track the movement of a person within at least one organization, wherein the objects include reports, charts, and documents.

In another aspect, the invention features a system for implementing a merger of at least two organizations, wherein the system can include a software tool presenting a user with at least one of a personalized object, a preferred object, a recently accessed object, and a merger-related object.

In another aspect, the invention features a computer system for implementing a merger of at least two organizations, wherein the computer system can include a first module for budget planning and a second module for headcount quota planning, wherein the module can include a graphical user interface.

In embodiments, the graphical user interface can include a job description, a number of open positions, a number of filled positions, and at least one of a planning period and a time interval. The graphical user interface can allow a user to add, delete, and edit positions.

In another aspect, the invention features a system for implementing a merger of at least two organizations, wherein the system can include a computer module for headcount analysis, wherein the computer module can include a user interface adapted to present a chart of employee headcount information for a time period.

In embodiments, the system can include a user interface adapted to edit information for one or more personnel of at least one of the merger organizations. The user interface can include a link to an interface for at least one of a promotion request, an internal reassignment, a personnel transfer, a special payment request, and a change of personnel groups.

The system can also include an organizational planning interface, wherein the organizational planning interface can include information personalized for at least one of the organizations and a greeting message personalized for an organizational planning interface. The organizational planning interface can be adapted to facilitate a redeployment of one or more employees, wherein the organizational planning interface further can include a panel and information for at least one of an office overview, a functional overview, a divisional overview, and a status overview of at least one of the organizations.

The panel can present at least one of a number of positions, a number of assigned positions, and a number of unassigned positions, wherein the panel can include a graph presenting a status of employee transitions and placements.

The organizational planning interface further can include information for one or more organizational headcounts pending approval, information for a financial impact, information for employee layoffs, and one or more issues for employee redeployment, wherein the one or more issues for employee redeployment can include an indicator of a priority level for an issue, a date of creation of the issue, and a name of one or more stakeholders presenting the issue.

The organizational planning interface further can include at least one of a link presenting an employee redeployment, a link presenting an organizational personnel structure, a link presenting a headcount planner, a link presenting an employee retention tool, and a link presenting an employee compensation tool.

In another aspect, the invention features a system for implementing a merger of first and second organizations, wherein the system can include a first user interface for the first organization, wherein the first user interface can include human resource information, a second user interface for the second organization, and a link relating the first and second user interfaces.

In embodiments, at least one of the interfaces present at least one of an organizational information, a financial statement, an organizational historical statement, a background statement, an investor information, and answers to frequently asked questions, wherein at least one of the interfaces further presents at least one of an employee headcount, a headcount category, a history of headcount transitions, a predicted headcount transition, and a menu of one or more disparate interfaces, wherein the menu can include one or more interface links for at least one of a management plan, a transition plan, a management initiative, and a risk management overview.

In another aspect, the invention features a system for implementing a merger of at least two organizations, wherein the software product can be adapted to present an interface for planning, managing, and assessing human resource information, wherein the human resource information can include at least one of a hiring date, a benefit scale, and an indicator of employee absenteeism.

In embodiments, the system permits a user to define one or more parameters for absenteeism, wherein the indicator can include a graphical calendar emphasizing one or more days of absenteeism, wherein the human resource information further can include a picture of one or more employees.

The system further can include a module adapted to track a realization of merger objectives, wherein the merger objectives comprise tangible and intangible merger objectives, wherein the intangible merger objectives comprise a product brand recognition for one or more customers and one or more cultural issues of employees of at least one of the organizations.

The system further can include a module adapted to track a cultural effect of organizational changes.

The system further can include a module adapted to track one or more interfaces between a first group of a first organization and a second group of a second organization, wherein the one or more interfaces can include input data, output data, and information related to one or more reports.

### BRIEF DESCRIPTION OF THE DRAWINGS

These and other aspects will now be described in detail with reference to the following drawings.

FIG. 1 is a block diagram of an exemplary system.

FIG. 2 is a flow diagram of a mergers and acquisitions integration process.

FIG. 3 is a block diagram of architecture.

FIG. 4 is a block diagram of a platform.

FIG. 5 is a merger flow diagram.

FIG. 6 is an interface.

FIG. 7 is an interface.

FIG. 8 is an interface.

FIG. 9 is an interface.

FIG. 10 is an interface.

FIG. 11 is a panel.

FIG. 12 is a graph.

FIG. 13 is an interface.

FIG. 14 is a panel.

FIG. 15 is an interface.

FIG. 16 is a panel.

FIG. 17 is an interface.

FIG. 18 is an interface.

FIG. 19 is a panel.

FIG. 20 is an interface.

FIG. 21 is an object.

FIG. 22 is an interface.

FIG. 23 is an interface.

FIG. 24 is an interface.

Like reference numbers and designations in the various drawings indicate like elements.

### DETAILED DESCRIPTION

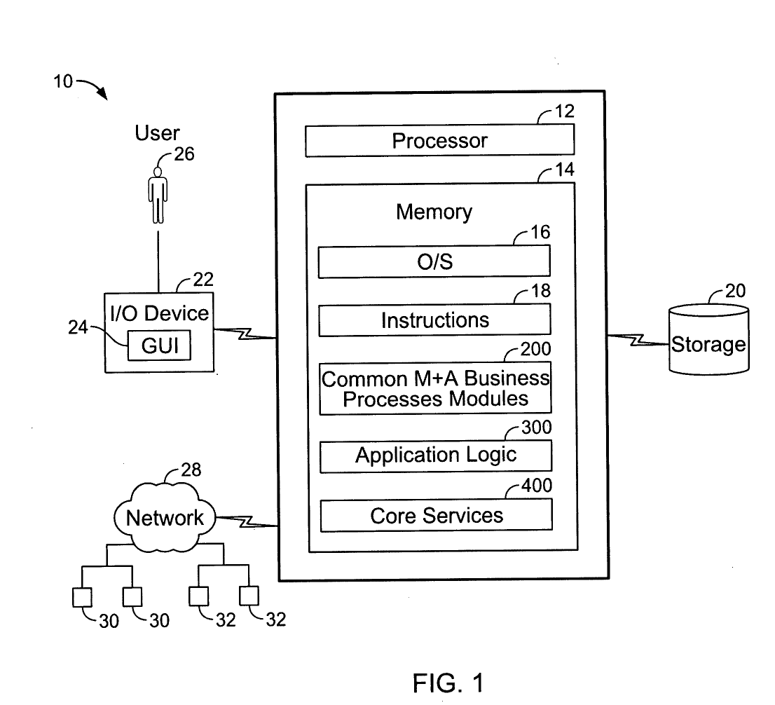

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

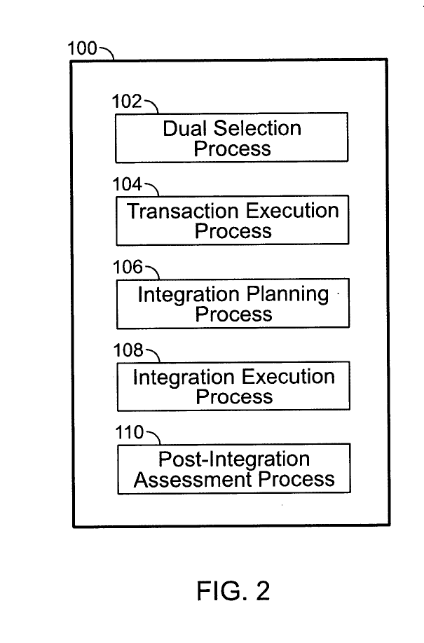

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly. The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

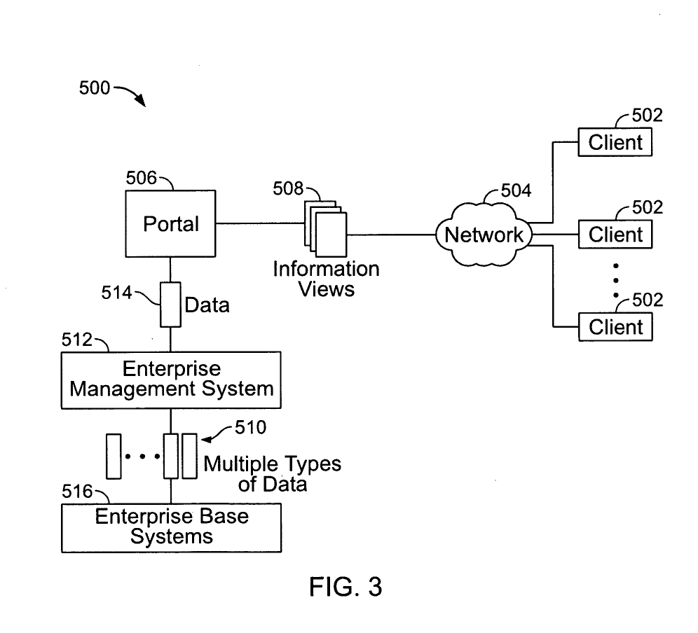

As shown in FIG. 3, the restructuring integration process 100, common restructuring business processes modules 200, application logic 300, and core framework of services 400 are designed to conform to an architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508. The portal 506 receives requests from the clients 502 and generates information views (iViews) 510, such as web pages, in response. In embodiments, the portal 506 implements a user roles-based system to personalize a common interface and the iviews 510 for a user of one of the clients 502. The user can have one or more associated roles that allow personalized tailoring of a presented interface through the iviews 510.

The portal 506 communicates with an enterprise management system 512 that consolidates multiple application services.

The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” are two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

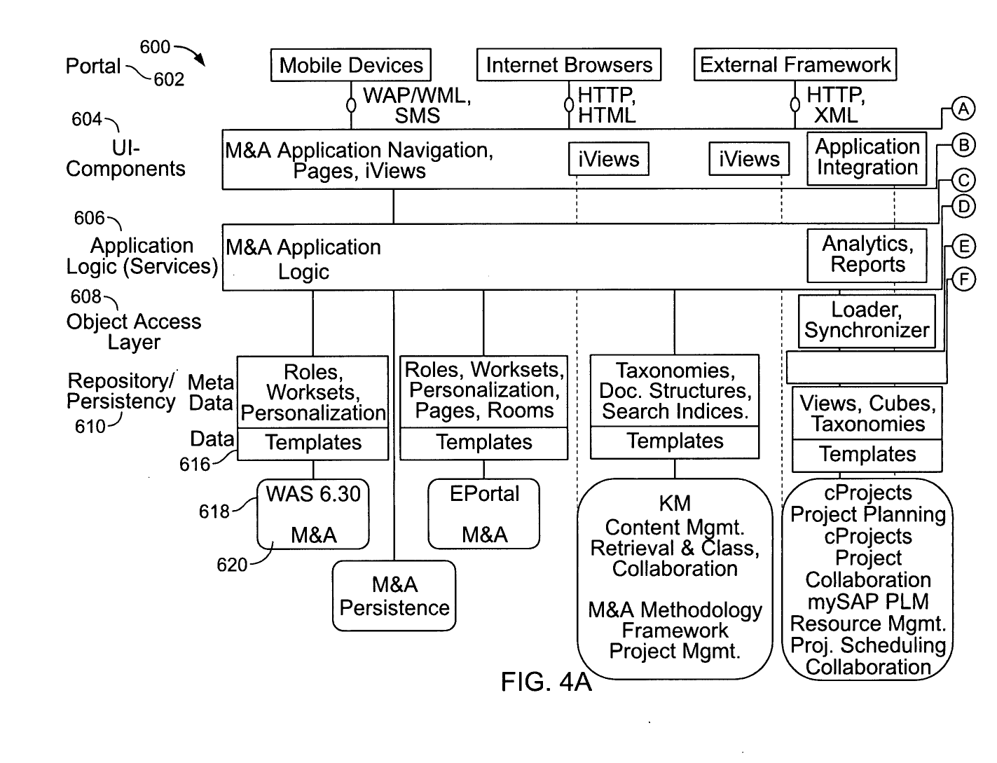

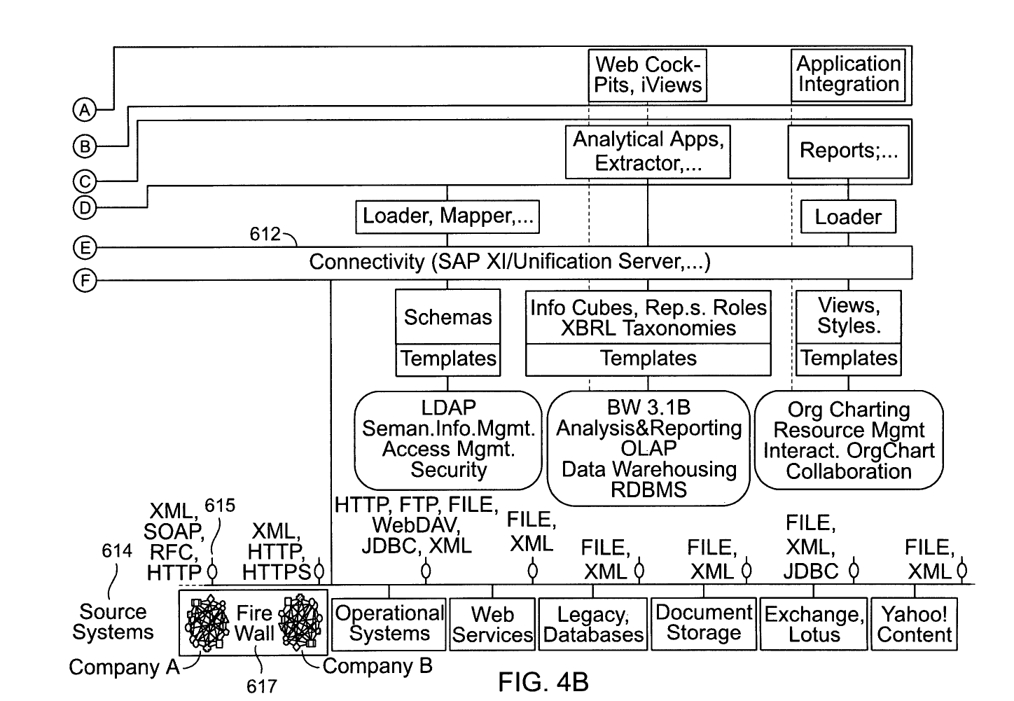

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as SOAP, request for comments (RPC), or TCP/IP. The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

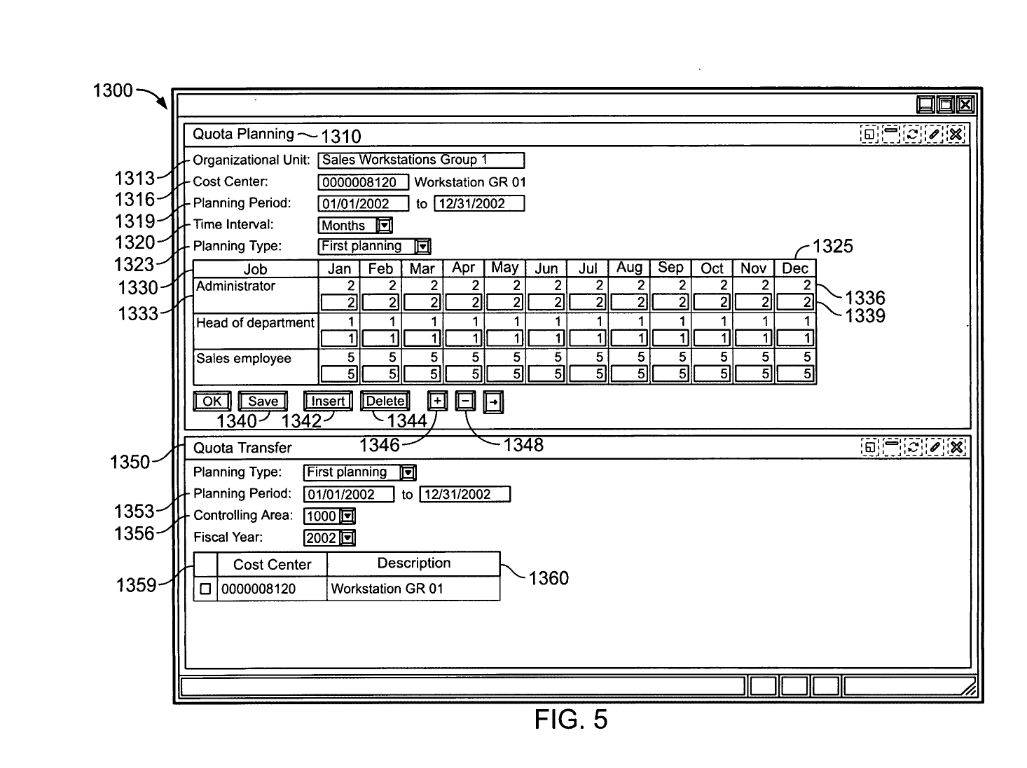

FIG. 5 shows an example of an interface 1300 for a headcount quota tool. The interface 1300 presents a quota planning panel 1310, and a quota transfer panel 1350. In the quota planning panel 1310, a user can view an organizational unit 1313, cost center 1316, and planning type 1323. The user can also inspect the quota planning 1310 for a planning period 1319 in a time interval 1320, such as a time interval of months 1325. The interface 1300 shows a job description 1330, such as administrator positions 1333, with the number of desired positions 1336, and the number of filled positions 1339. The interface user can use a save button 1340, insert button 1342, or delete button 1344, to control job types 1330. The user can use an add button 1346, delete button 1348, or edit button to control job positions at row 1339.

The quota transfer panel 1350 presents an organizational controlling area 1356 and planning period 1353. The panel 1350 can also show a cost center 1359 and related description 1360.

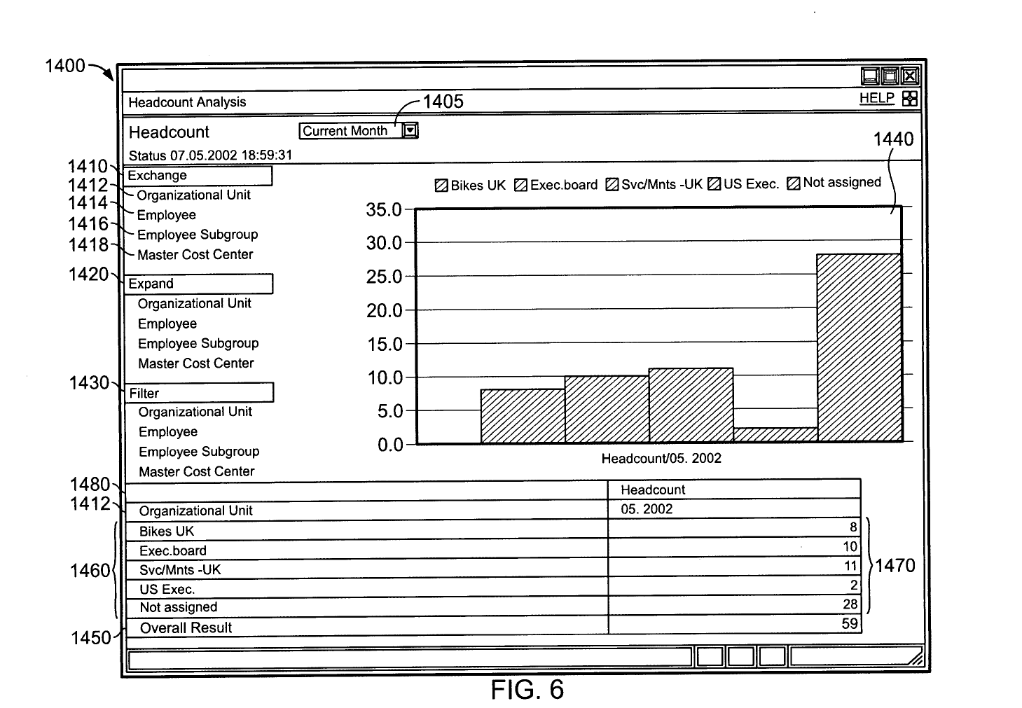

FIG. 6 illustrates an exemplary user interface 1400 for a headcount analysis. The user interface 1400 can present the headcount for a time period 1405, and allows a user to exchange 1410, expand 1420, or filter 1430 one or more organizational units 1412, employees 1414, employee subgroups 416 or cost centers 1418. The user interface 1400 displays a chart 1440 and/or table 1480 for groups 1460 in an organizational unit 1412, as well as the number of members 1470 in each group 1460. The total number of members 1450 for the organizational unit 1412 can also be displayed. The user interface 1400 can be part of the module 200.

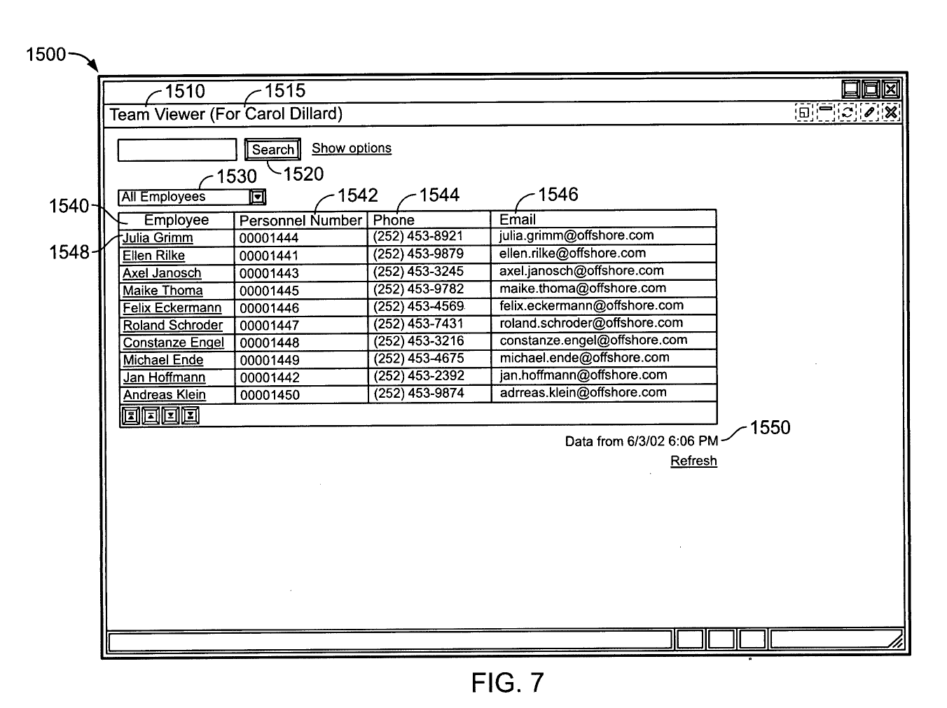

FIG. 7 illustrates an exemplary interface 1500 to present group or team information to a user 1515. The interface 1500 shows a personalized view of a team 1510 for user Carol Dillard 1515. By using a selector 1530, Carol 1515 can examine a list of employee 1530 team members along with their related contact information.

The selector 1530 can also help the user to find a list of team members by an identifier, such as by a personnel number 1542, or by another member identifier. The interface 1520 can interact with a search engine to locate team members by employee name 1548, personnel number 1542, phone number 1544, or email address 1546. The interface 1500 can also display a real time (e.g., the moment the interface accesses and displays information) 1550 of the team information.

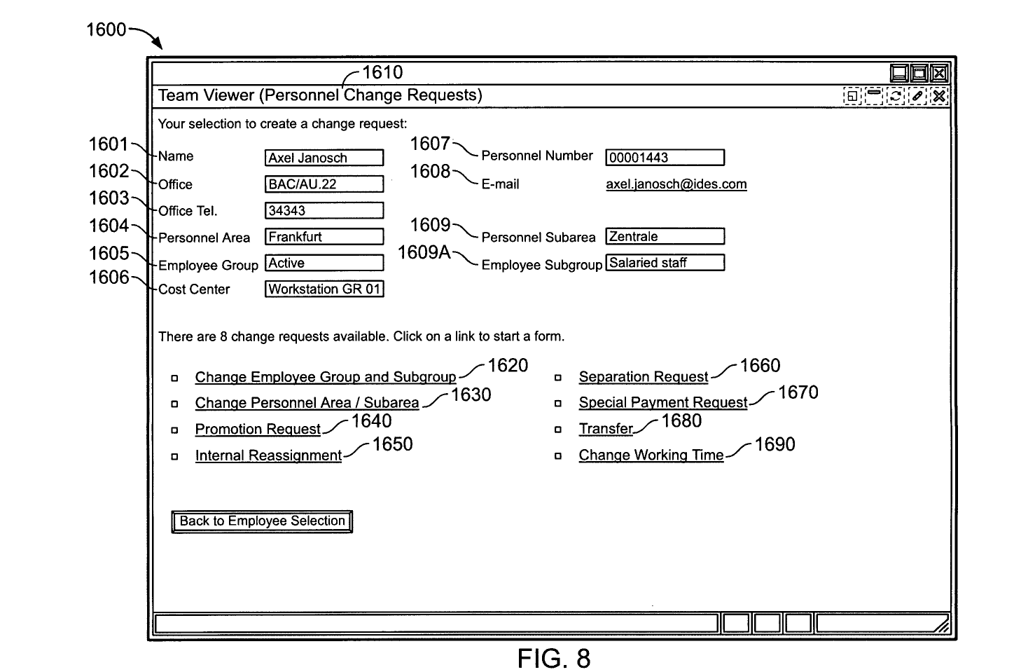

FIG. 8 illustrates an interface 1600 for a user to submit a request 1610 for a personnel change in an organization. The interface 1600 allows the user to easily edit information for an employee. For example, the interface 1600 allows the user to edit an employee's name 1601, office information 1602, telephone number 1603, personnel area 1604, employee group 1605, cost center 1606, personnel number 1607, email address 1608, personnel sub area 1609, and employee subgroup 1609A. The interface 1600 also includes links 1620-1690 to other interfaces to perform other organizational human resource tasks. The other exemplary links include a change to an employee's group or subgroup 1620, a change to a personnel area 1630, a promotion request 1640, an internal reassignment 1650, a separation request 1660, a special payment request 1670, a transfer 1680, and a change to working time 1690.

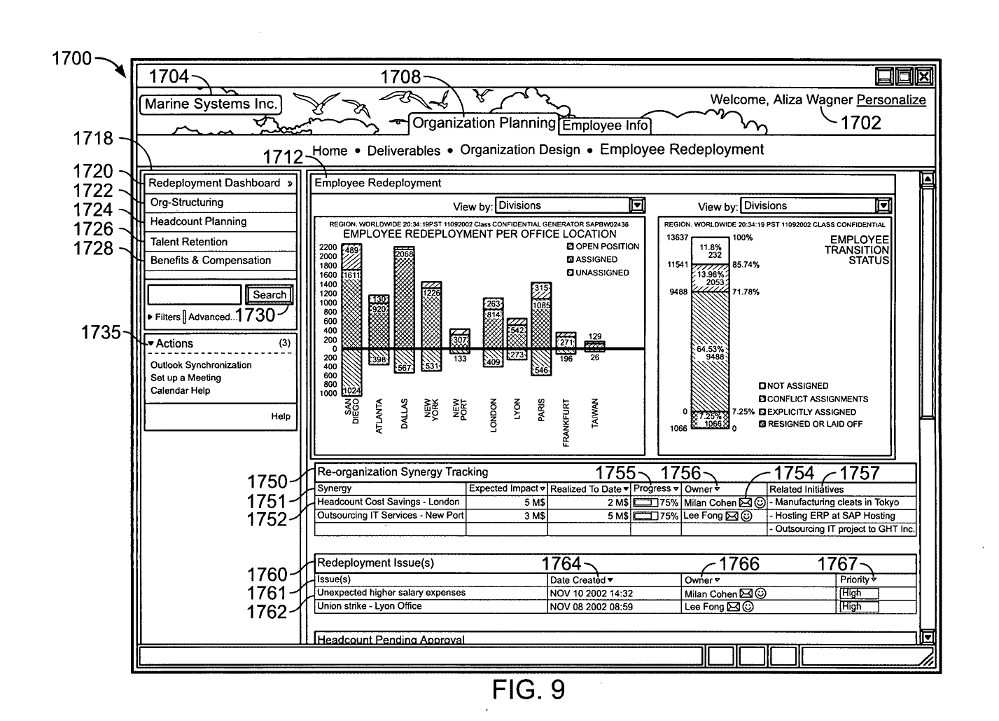

FIG. 9 illustrates an exemplary organizational planning interface 1700. The user interface 1700 can be part of a module to restructure an organization and can allow a user to edit merger-related information. The interface 1700 can have a tab 1708 with a menu of user views. The tab name 1708 can identify if a user is part of a particular merger group. The tab name 1708 can also indicate if the user 1702 has permission to access an organizational planning interface 1700. For example, if a tab is absent from a user's interface then the user can not be part of a particular merger group and can not have access to information relating to that group or tab name 1708. The user interface 1700 can be formatted, organized, and personalized (e.g., icon 1704) based on preferences of the organization or the related industry.

The interface 1700 allows a user to track one or more employees during the merger and present information that is editable and indicative of a performance level of one or more employees. The interface 1700 also allows a user to devise one or more retention plans and presents a performance information of a group or division in at least one of the organizations.

The organization planning interface 1708 presents a panel 1712 for employee redeployment, a panel 1750 for re-organization synergy tracking, and a panel 1760 for redeployment issues 1760. The user 1702 can also access a panel 1718 in which the user can access links to present a redeployment dashboard 1720, an organizational structuring view 1722, a headcount planning view 1724, a talent retention view 1726, and a view 1728 for benefits and compensation. The panel 1718 can also permit the user 1702 to access other organization information with a search query 1730. The panel 1718 can have other actions 1735 for the user 1702 to plan, manage, and communicate merger-related organizational planning tasks.

In the re-organizational synergy tracking panel 1750, the user 1702 can plan and manage organizational planning-related synergies. The term “synergy” can refer to cooperative interaction among groups, especially among the acquired subsidiaries or merged parts of an organization, to create an enhanced combined effect. A “synergy” can be a value, performance, or effect that can be achieved as resources of two organizations combined will be greater than the sum of the separate individual resources. The interface 1700 allows the user 1702 to inspect the progress 1755 of a synergy 1751, such as a headcount cost savings 1752 in a London office. An owner 1756 of the synergy 1751 can be identified, and contacted with an electronic object (e.g., email 1754). The user 1702 can also determine if a synergy 1751 has a related initiative 1757 or organizational action.

Additional organizational planning issues can be addressed in a redeployment issues panel 1760. The panel 1760 presents a list of issues 1761, the date an issue was created at 1764, and the person 1766 who created the issue. An issue 1762, such as unexpected higher salary expenses, can be tagged with a priority indicator or level 1757 (e.g., high, normal, or low). The panel 1760 allows the interface user 1702 to expeditiously address critical redeployment issues throughout the merger process.

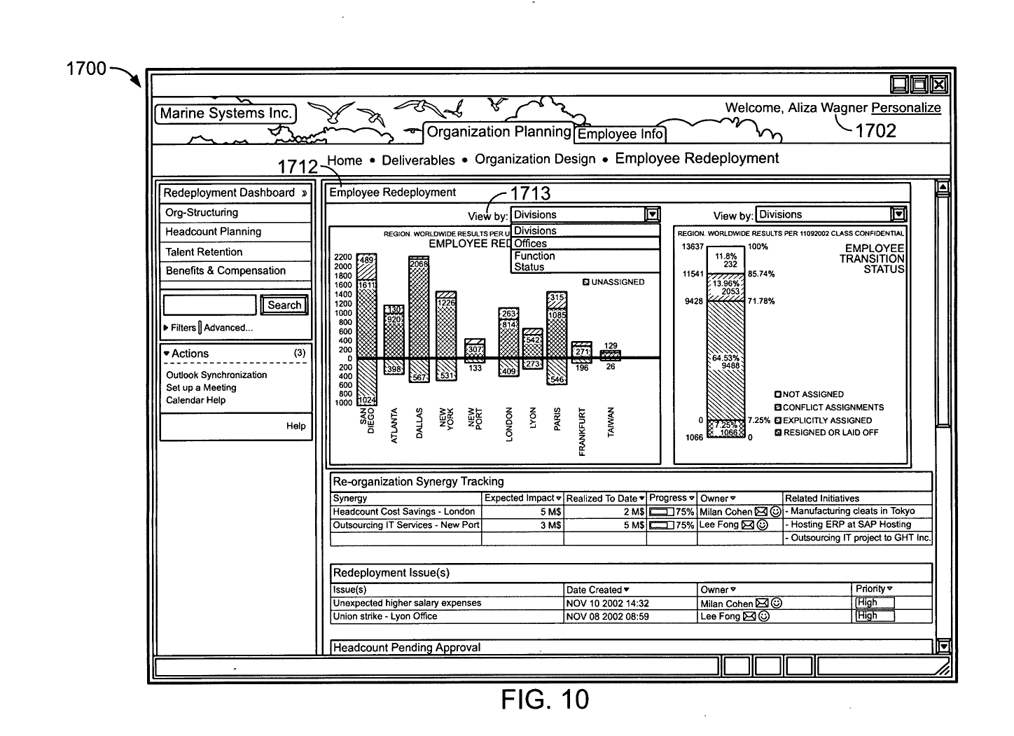

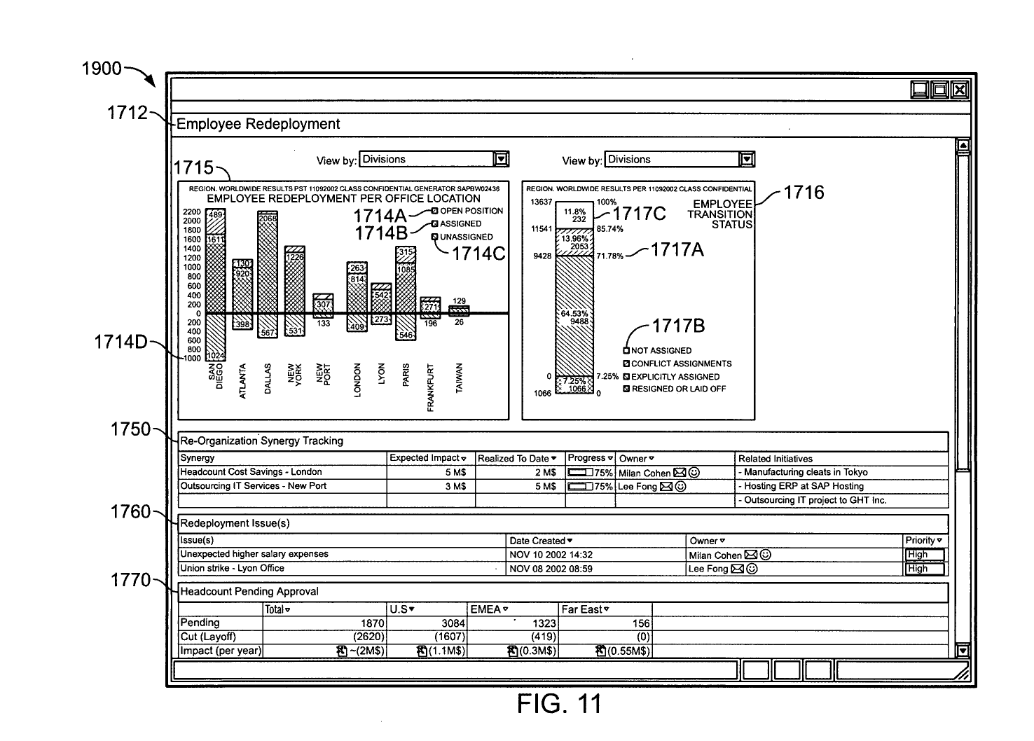

Divisions, offices, function, and status views 1713 can be presented in the employee redeployment panel as illustrated in FIG. 10. A graph 1715 of the employee redeployment per office location can be presented, as shown in FIG. 11. The graph 1715 can show a number 1714D of positions that are open 1714A, assigned 1714B, or unassigned 1714C for a given office location. Another graph 1716 presents the status of employee transitions or placements. The transition graph 1716 displays the percentage 1717A or number of total positions for a particular status. For example, the number 1717C of unassigned positions 1717B is displayed as “232 unassignments”, or as 11.8% of allocated assignments.

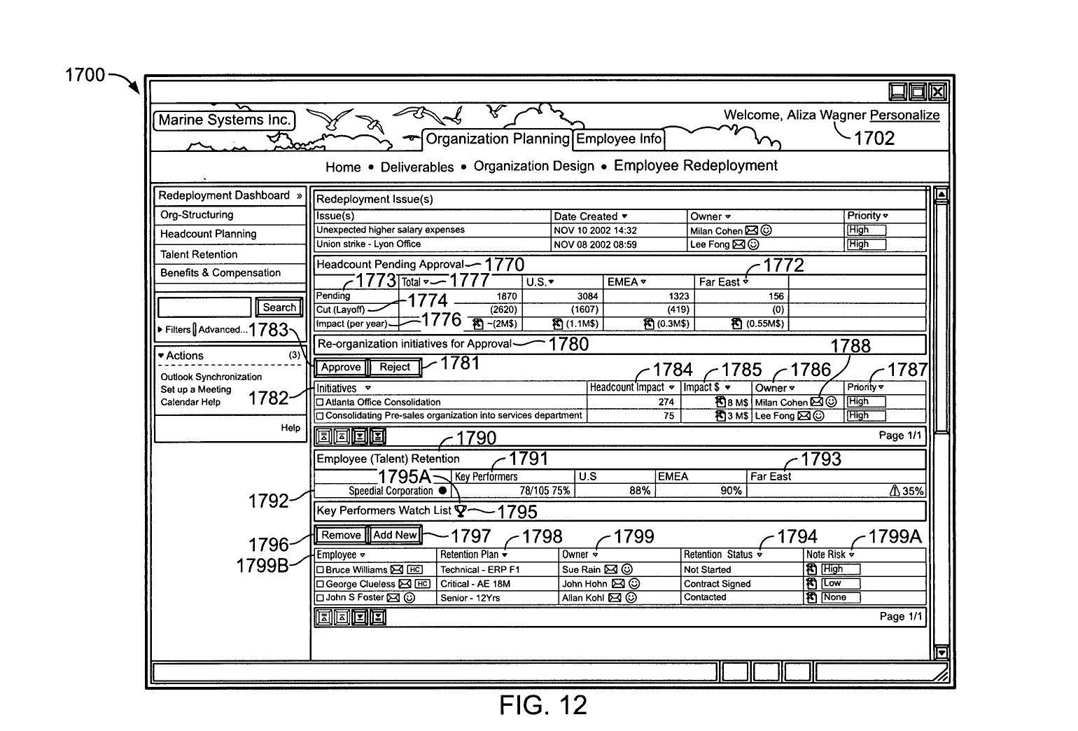

FIG. 12 illustrates another view of the organizational planning interface 1700. Organizational headcounts with pending approval are shown in panel 1770. An interface user 1702 can examine the pending positions based on a total allotment 1777, or a particular region of the organization, such as a Far East region 1772. The displayed headcount approval can be for pending redeployments 1773 or pending layoffs 1774. The user 1702 can even inspect the financial impact 1776 of the pending positional approvals.

In addition to presenting the pending headcounts for approval 1770, the interface 1700 can present the re-organizational initiatives for approval in a panel 1780. The user 1702 can select to approve 1783 or reject 1781 initiatives 1782 when assessing organizational headcount 1784 and financial 1785 impacts. The user 1702 can use email 1788 to communicate with the owner 1786 of the initiative 1782. The user 1702 can also first address the most urgent initiatives based on an initiative priority indicator 1787.

FIG. 12 illustrates a panel 1790 to maintain and track talented employees. The user 1702 can view the key performers 1791 in an organization 1792. The user can also determine if a particular region or division of the organization has a larger or smaller percentage of key performers. For example, the Far East 1793 region or division of Speedial Corporation 1792 has 35% of personnel as key performers in that region 1793. As a result, Speedial can want to layoff the non-key performers in one or more divisions during a merger.

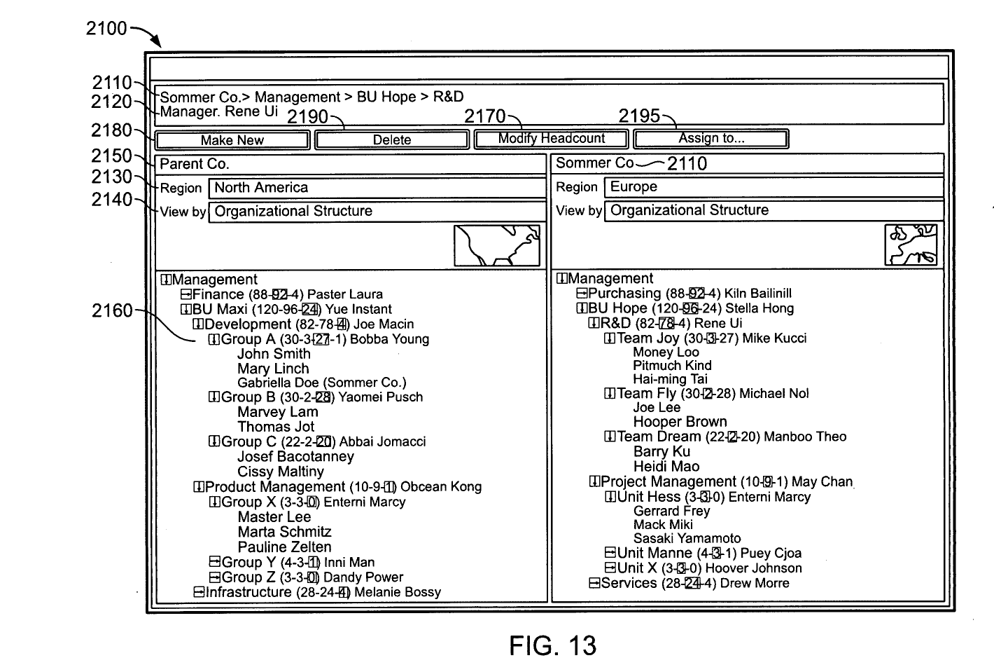

FIG. 13 illustrates a panel 1795 to track and retain individual key performers in an organization. The panel 1795 can include information relating to a personnel retainment strategy, in which the information can include information for a geographic region of at least one of the organizations. An icon 1795A next to a panel 1795 or an organizational member can identify to the user 1702 if the panel 1795 or member relates to an organizational key performer. The user 1702 can add 1797 or remove 1796 key performers from the panel 1795 list. Members 1799 of the organization can also make targeted retention plans 1798 for key performers 1799B, along with related retention status indicators 1794. The user 1702 can also assess the risk 1799A of key performers who are likely to leave the organization during merger.

FIG. 13 shows an example page 2100 for a manager 2120 involved in planning the headcount of the merger and acquisition. The example page 2100 can have a first user interface for a first organization and a second user interface for a second organization, in which both interfaces present one or more employees from each respective organization. A headcount planning module can view the organization by the region 1130 and employee function in the company. In this example, the headcount planning module can modify (via a button 2170) the current headcounts at the parent company 2150 according to the headcount information from Sommer Company 2110. The headcount planning module can also create (via a button 2180) or delete (via a button 2190) a division, team, group 2160, or unit in the parent company to accommodate the employees from Sommer Company. Depending on the staffing needs of Sommer Company 2110 and the parent company 2150 in the merger process, employees can be assigned (via a button 2195) to a particular department. Other headcount planning and employee redeployment tasks, such as notifying a line manager of headcount changes, can be performed in related organizational restructuring interfaces.

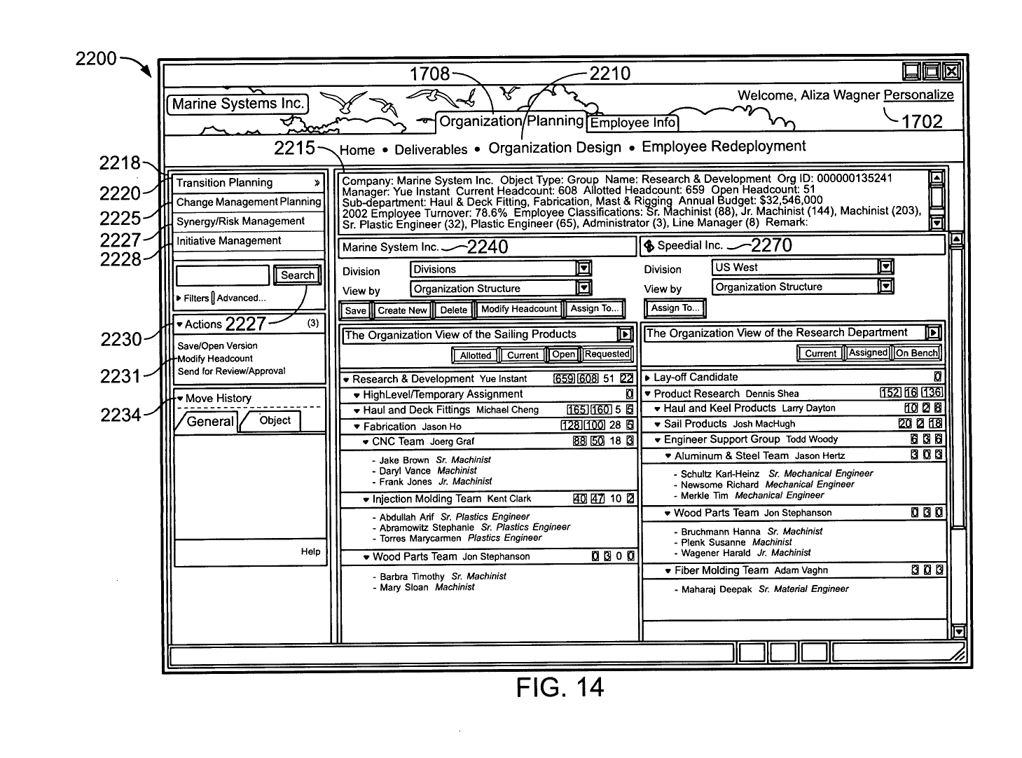

FIG. 14 illustrates an exemplary organizational design interface 2200. The interface 2200 can be selected by a user 1702 in the organizational planning menu 1708. The interface 2200 can include a panel 2240 for an acquiring organization, such as Marine Systems Inc., and a panel 2270 for an acquired organization, such as Speedial Inc. The interface 2200 also includes a link to relate one or more interfaces of human resource information for each merger organization. The organizational design interface 2200 can be part of the strategic organizational design and transition planning features 1140.

A “fact sheet” panel 2215 can display organizational information, such as a financial statement, an organizational historical or background statement, investor information, and answers to frequently asked questions (FAQs). The “fact sheet” panel 2215 can also display one or more details for a particular merger group, employee headcount, headcount types, previous headcount transitions, and predicted headcount transitions.

Another panel 2218 in the interface 2200 permits the user 1702 to display various interface views, such as a transition planning view 2220, a change management planning view 2225, a synergy/risk management view 2227, and an initiative management view 2228. The user 1702 can enter a search query 2227, and perform other actions 2230 related to organizational planning 1708, such as modifying headcount 2231. Additionally, the panel 1218 can allow the user to access a history 2234 of member and group movements during a merger.

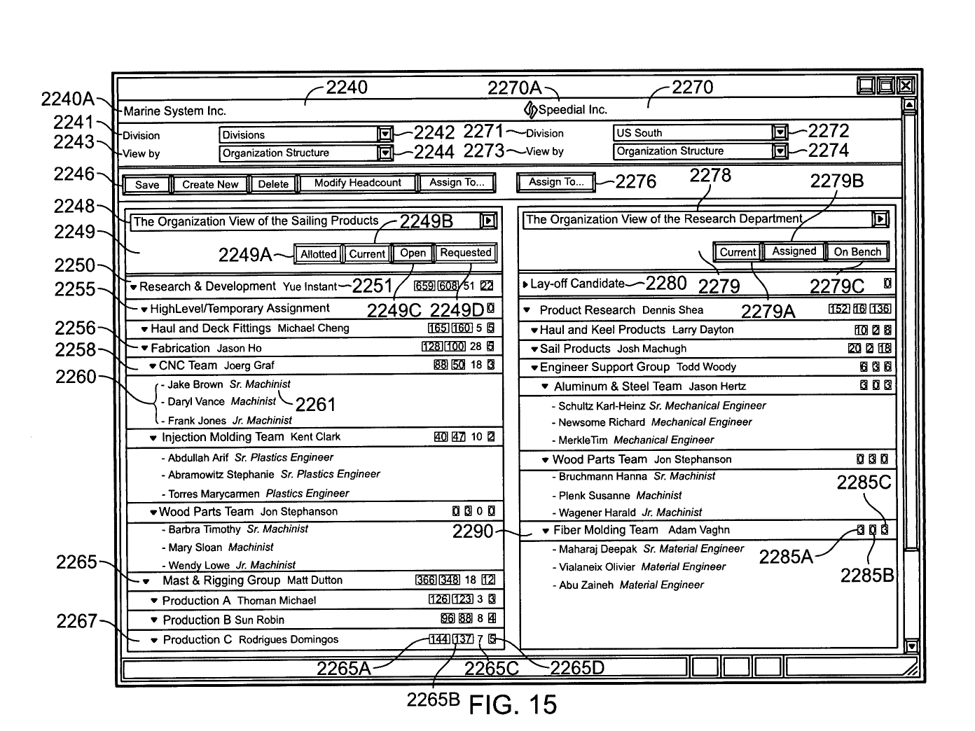

FIG. 15 presents a panel 2240 for the acquiring organization, and a panel 2270 for an acquired organization. The panels 2240 and 2270 enhance organizational design efforts when planning new headcounts, shifting headcounts, or tracking transition changes. Additionally, the panels 2240 and 2270 assist in employee reassignments by searching and matching resources, and tracking the status of employee movements.

The panel 2240 presents a view 2248 of the acquiring organization 2240A. A user 1702 can elect a division 2241 of the organization 2240A with a selector 2242. The selector 2242 can open a pull-down menu of options such as divisions, offices, function, or status. The user 1702 can also select a view 2243 with another selector 2244. The selector 2244 can open a pull-down menu of viewable options such as organizational structure, job function, and grade. Furthermore, the panel 2240 presents other options 2246 to the user 1702 including saving a profile, creating a new profile, deleting a profile, modifying organizational headcount, or making an assignment to a member of one or more organizations.

The organizational view 2248 of the sailing products can display a hierarchy of departments such as research and developments 2250 and fabrication 2256. The panel 2240 can identify a leader 2251 of each department, and members of a group 2260, including an organizational title 2261 for each member. The status of a number 2249 of positions can also be displayed for each division, group, or subgroup. For example, the Production C subgroup 2267 in the Mast and Rigging Group 2265 presents a number 2265A of allotted positions 2249A, a number 2265B of current positions 2249B, a number 2265C of open positions 2249C, and a number 2265D of requested positions 2249D. The panel 2240 can also show the status of transitional personnel or personnel with temporary assignments 2255.

Panel 2270 presents an organizational view 2278 of a research department of an acquired organization 2270A, Speedial Inc. In panel 2270, a user 1702 can elect a division 2271 of the organization 2270A with a selector 2272. However, the selector 2272 can open a different pull-down menu than the selector 2242 of panel 2240. For instance, the selector 2272 can open a pull-down menu of options displaying regional organizational divisions such as US South, US East, US West, and US Central.

As in panel 2240, panel 2270 can present information to display the status of a number of positions for each division or group. For instance, panel 2270 shows that the Fiber Molding Team 2290 has a number 2285A of current positions 2279A, a number 2285B of assigned positions 2279B, and a number 2285C of undetermined positions 2279C. The panel 2270 can even display layoff candidates 2280.

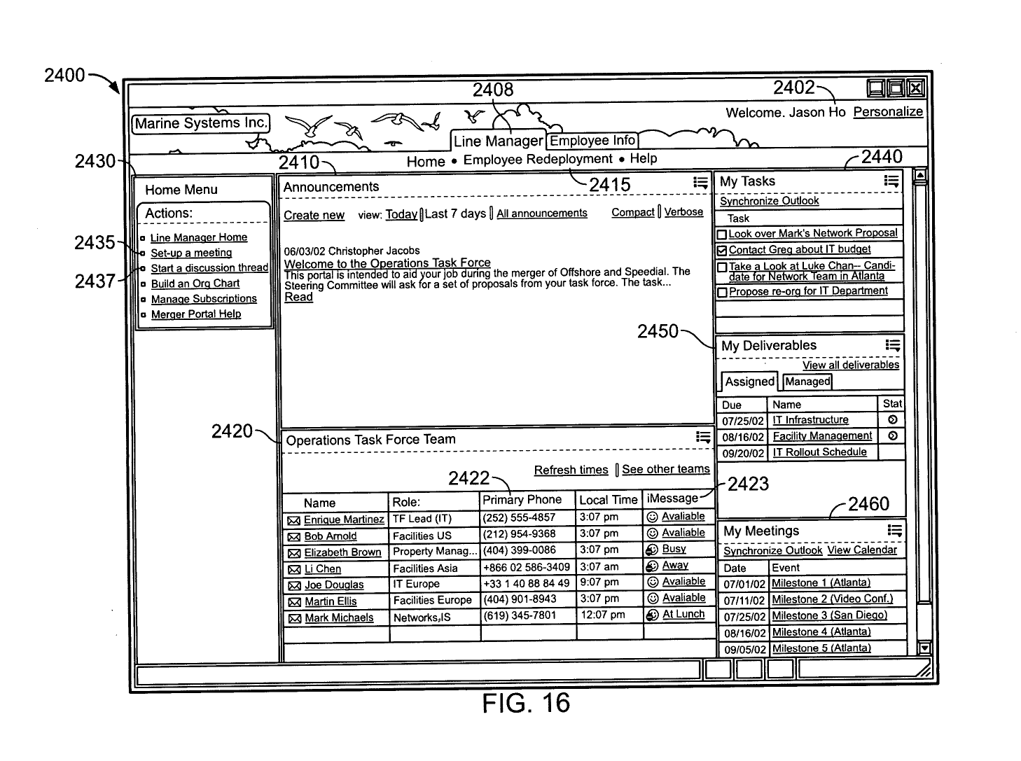

FIG. 16 illustrates an exemplary view of an interface 2400 for a line manager 2402. The interface 2400 can be personalized 2402 for the line manager 2402, and greet the line manager 2402 with an announcement panel 2410. The line manager 2402 can view a panel 2420 of the operations task force team, along with the contact information 2422 and availability 2423 of team members.

The interface 2400 allows the line manager 2400 to collaborate with other members to conduct organizational design tasks such as arranging a meeting 2435 or starting a discussion thread 2437 with panel 2430. The interface 2400 can have personalized panels for tasks 2440, deliverables 2450, and meetings 2460.

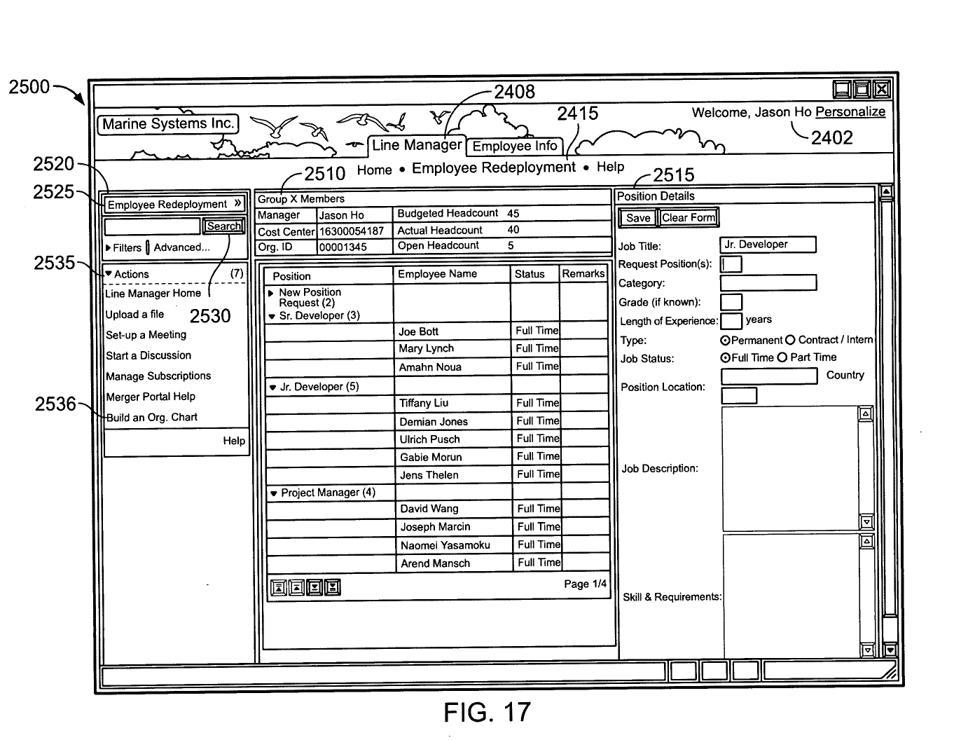

FIG. 17 illustrates an employee redeployment interface 2500 for the line manager 2402. For this interface 2500, an employee redeployment indicator 2415 is selected. The interface 2500 shows a panel 2510 for members of a group, a panel 2515 for positional details, and a panel 2520 with other navigational abilities for the user 2402. In panel 2520, the user 2402 can access an employee redeployment navigation indicator 2525, a search query interface 2530, and other user actions 2535, such as building an organizational chart. The employee redeployment interface 2500 can be part of the redeployment request features 1150.

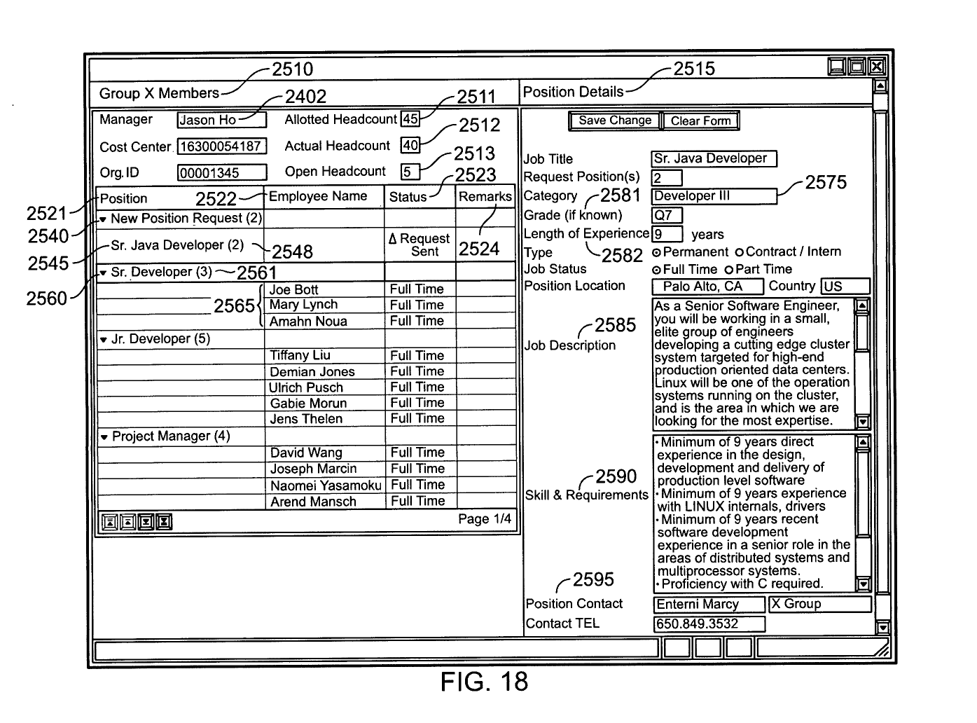

FIG. 18 presents panel 2510 and panel 2515 from interface 2500, in which panel 2515 has completed information fields, such as field 2575. In panel 2510, the line manager 2402 can examine an allotted headcount value 2511, an actual headcount value 2512, and a value 2513 of open headcounts. The line manager 2402 can inspect a status 2523 for organizational positions 2521 with accompanying descriptions and remarks 2524. The line manager can also access the positions in an organization by the title 2560 of the position, and view a number 2561 of members 2565 listed under a particular position.

Panel 2510 can also present new position requests 2540, in addition to the types 2545 and numbers 2548 of the new position requests 2540. A position request 2545 is detailed in panel 2515 with completed fields, such as a job description 2585, and skills, experience, requirements, and work history 2590. A positional grade level 2581 and length of experience 2582 can also be displayed in panel 2515. The position detail panel 2515 can also associate a position with a contact person 2595.

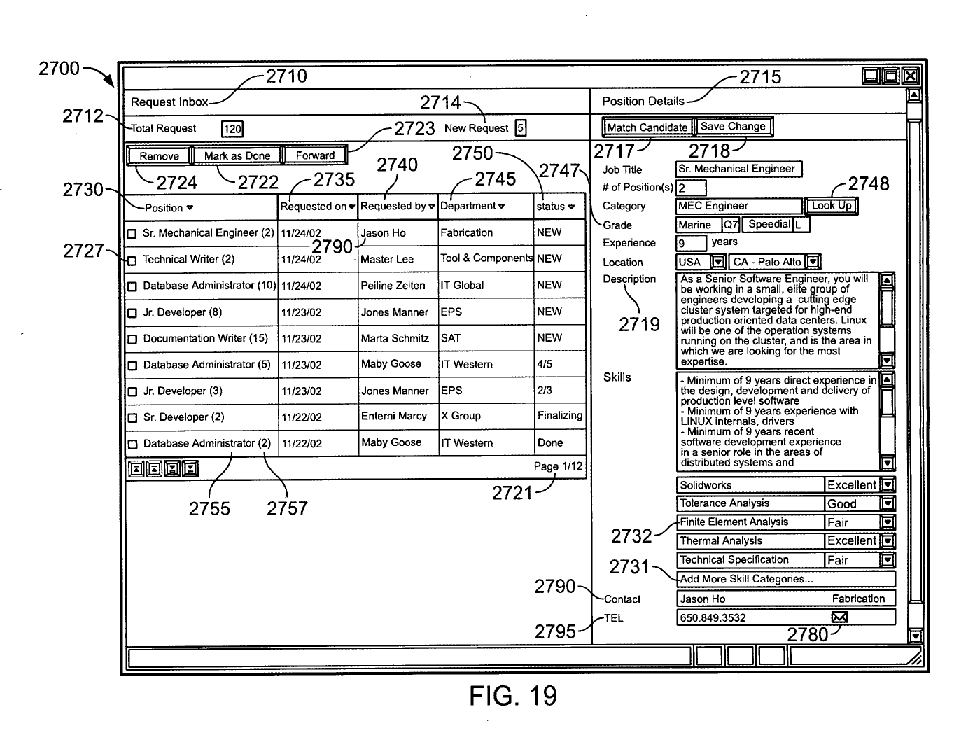

FIG. 19 shows a panel 2710 for an inbox designated for position requests, and another panel 2715 that details position parameters, such as a description 2719 of a position. The panel 2710 presents a number of total requests 2712, and a number of new requests 2714. The panel shows positions 2730 in the inbox, such as database administrators 2755. An interface user can view listed positions 2730, a date 2735 that the positions were requested, a person 2740 who submitted the position request, a department 2745 that submitted the request, and a status 2750 of each request in the inbox.

In panel 2710, a user can remove 2724 or forward 2723 an inbox request. A user can select an indicator 2722 or select a checkbox 2727 when an inbox request has been answered or completed. If all of the inbox requests are not displayed in 2710, then a user can also navigate to other inbox request pages or panels 2721.

In panel 2715, a user can indicate if a candidate matches a position at 2717 and then save any changes to the position details at 2718. Panel 2715 permits the user to edit and customize parameter fields. For instance, the user can select to add more skill categories 2731 for various positional details, such as a ranking of finite element analysis skills 2732. The panel 2715 can provide a relative scale of grade levels 2747 in positions between the acquired and acquiring organizations. A “help” or reference indicator 2748 in the panel can assist the user to comprehend various types of predefined position categories. Additionally, the person 2790 who submitted the position request can also serve as a contact person 2790. An email link 2780 and telephone address 2795 can also be displayed for the contact person 2790.

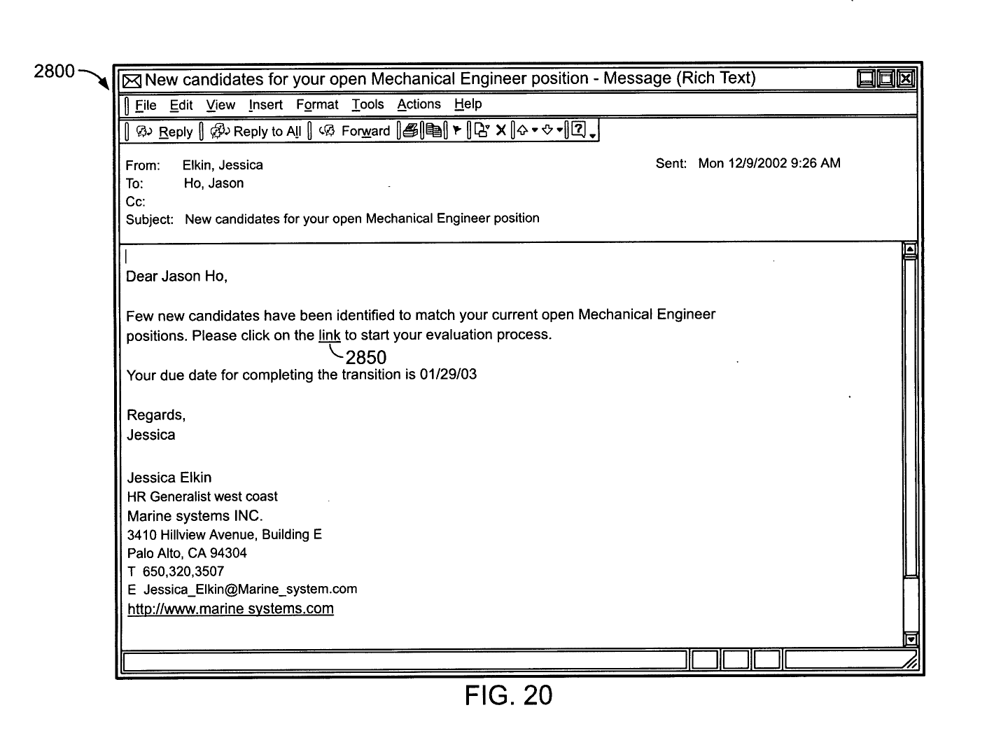

FIG. 20 illustrates an electronic object 2800 (e.g., email) that can be generated as a result of the candidate review and tracking. In this example, a line manager can receive an email from the human resource generalist to inform him of potential new candidate matches for open positions in his group. The line manger can select the link 2850 from the email 2800 to view the candidates and to facilitate an evaluation process.

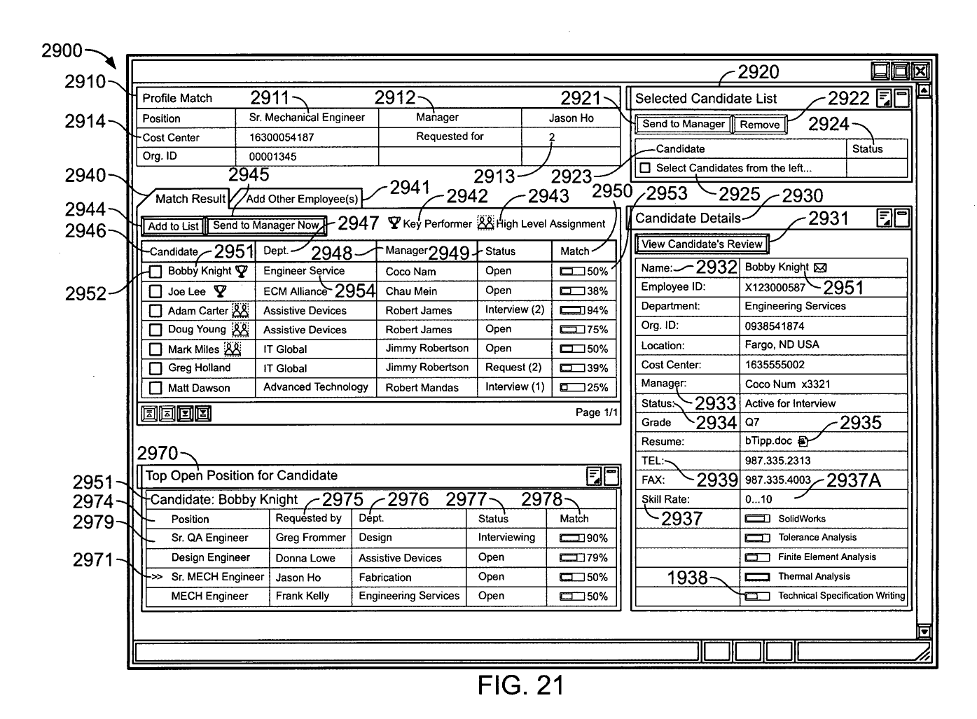

FIG. 21 illustrates an interface 2900 to aid merger organizations to identify, match, and retain candidates.

A profile match panel 2910 can allow a manager 2912 to find candidate matches for any number 2913 of requested positions 2911 in a designated group 2914, and to view profiles 2930 of candidates. Interface 2900 can be utilized as part of the strategic candidate assignment and redeployment tracking.

The manager 2912 can access a list of matches 2940, add other candidates to the list at 2941 and 2944, and inspect a measurement of a match to one or more parameters for a position. The list 2940 can present all of the candidates 2946 in the merger organization for targeted departments 2947 and managers 2948, along with an assignment status 2949 of the candidate 2946. The list 2940 can also indicate how well the profile 2930 of a candidate 2946 matches or meets the requirements for a position 2911 in a department 2947 via graphs 2953. For example, the list 2940 indicates that candidate Bobby Knight 2951 is a 50% match 2953 for a position in the engineer service department 2954. The list of 2940 can also indicate if a candidate is a key performer 2942 or if a candidate should have a high level assignment 2943.

The indicators 2943 and 2942 can help organizations retain key employees during a merger. Additionally, employees can be assured that their new assignment will match their skills and experience levels. With the help of such retention indicators, anxious employees can not become inclined to leave their organization during the merger. Consequently, merger organizations can not have to spend resources to locate, interview, hire, and train new personnel to replace departed personnel. Moreover, merger organizations can not have to spend resources on unproductive employees who are waiting for a proper assignment.

Other members of the merger organizations can access the list 2940. The other merger members can be managers, human resource personnel, executives, or officers. Such merger members can add candidates 2946 to the list 2940 via buttons at 2941 or at 2944, and immediately send a candidate profile to a manager at 2945. Such merger members can also note if a candidate is no longer available on the list with a selector (e.g., a check box) at 2952.

Panel 2970 can assist an organization in finding the most appropriate available position for a candidate based on matching their skills and experience with a listed open position. For example, candidate Bobby Knight 2951 has a profile 1930 that best matches a Sr. QA Engineer position 2979 as shown by Graphs 2978. A manager 2912 for a department 2976 can assess if the candidate 2951 is a good match 2978. An indicator 2971 can reveal to the manager 2912 that the available candidate 2951 is a better fit for other departments 2976. A status indicator 2977 can reveal if a particular department 2976 is currently interviewing for a position 2974.

In addition to panels 2910 and 2970, panel 2920 presents another tool for a panel user or manager 2912 to access the profiles of candidates with a panel such as panel 2930. Panel 2920 can interact with the list accessed from panel list 2940 and allow the manager 2912 to access the profiles of selected candidates at 2925. The manager 2912 can remove listed candidate profiles at 2922, or send listed candidate profiles to a manager at 2921.

In panel 2930, a user can access and view a review of a candidate 2951 at 2931. The panel 2930 can present various details of a candidate profile, including a manager 2933 for the candidate 2951, an indicator of the status 2934 of the candidate 2951, and contact information 2939 for the candidate 2951. The panel 2930 can also include a link 2935 to the resume of the candidate 2951. Furthermore, the panel 2930 can include an experience or skill rating 2937 for the candidate 2951. For instance, candidate Bobby Night 2951 has a rating in the middle of a scale 2937A for the skill of technical specification writing 2938.

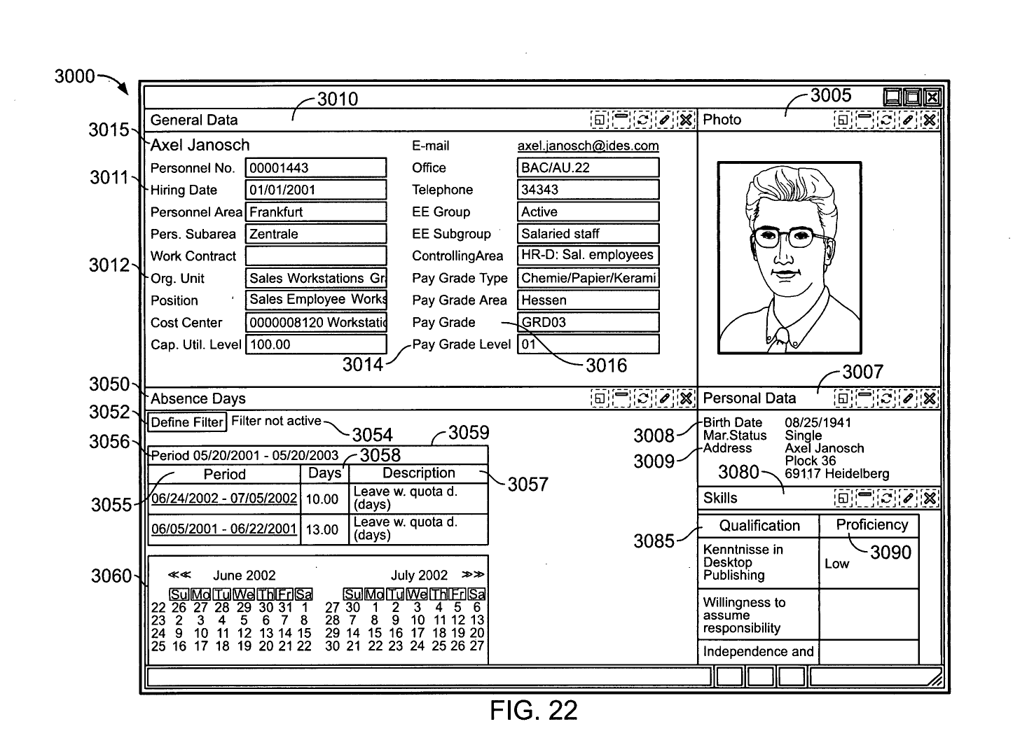

FIG. 22 illustrates an exemplary interface 3000 to assist in planning, managing, and assessing human resource information for a member of a merger organization. The interface 3000 can be utilized as part of a strategic candidate assignment 1160. Panel 3010 presents the general data of an employee 3015. The panel 3010 can display detailed human resource information on the employee 3015, such as a hiring date 3011, an organizational unit 3012, a pay grade 3016, and a pay grade level 3014.

Panel 3050 can present information on employee absenteeism 3050. A panel user can define a time period 3056 to view a chart 3059 with a description 3057 of absent days 3058 for various time periods 3055 for an employee 3015. The panel can also include a graphical calendar 3060 for the time period 3056. The graphical calendar 3060 can also help the panel user to select a time period 3056 and specific dates.

The panel 3052 can also permit the panel user to define parameters for organizational absenteeism at 3052. For example, an organization can have a number of personal days or vacation days for an employee 3015 that should not be counted as absent days. The organization can also have a holiday during the time period 3056 that should not be counted as an absent day.

Panel 3005 allows a panel user to visually identify an employee with a picture or photograph.

FIG. 22 further presents employee information in panel 3007. The panel 3007 can include employee data that can not be included in panel 3010, such as personal data. The personal data can include the birth date 3008 of the employee and the address 3009 of the employee.

Panel 3080 can contain information to exhibit the experience or skill level of an employee 3015. Such information can help a panel user to quickly evaluate the talent of the employee 3015. Such information can include one or more employee qualifications 3085, or proficiencies 3020.

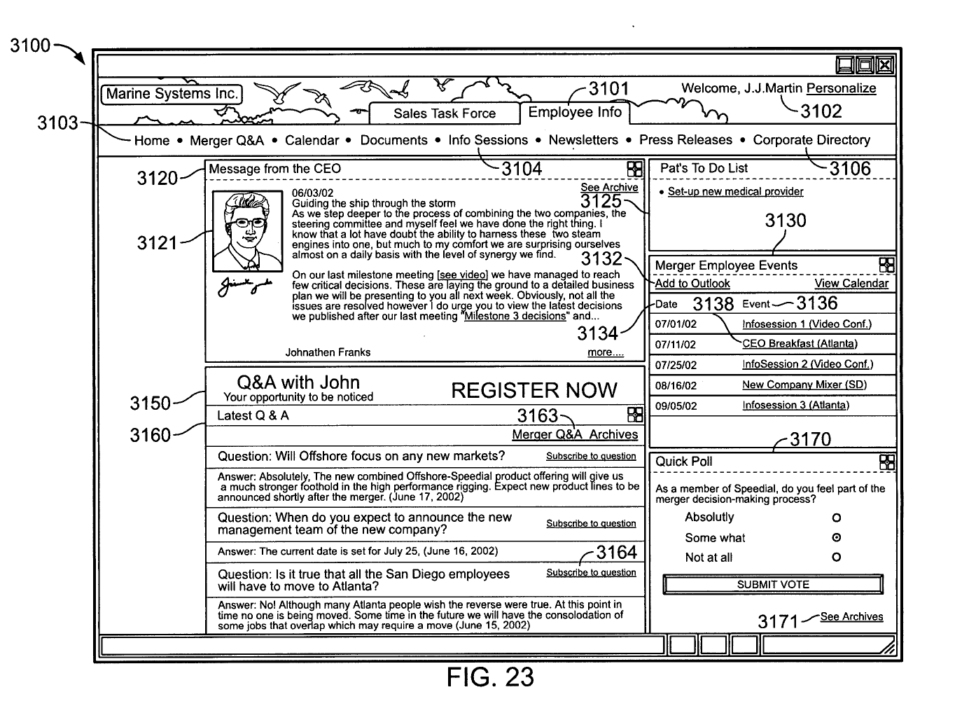

FIG. 23 illustrates an exemplary interface 3100 for an employee 3102 during a merger. The interface 3100 can have a personalized greeting for an employee 3102 and can be an intranet interface. A menu tab 3101 indicates that the interface 3100 is for an employee 3102. The employee 3102 can have a home page 3103, and other pages for communication and accessing information, such as an information sessions page 3104 or a corporate directory page 2106.

An executive of an organization, such as a chief executive officer (CEO) 3121, can update employees on the progress of the merger, as illustrated in panel 3120. The employee 3102 can also interact with the CEO 3121 with panels 3150 and 3160. Panel 3160 presents a question and answer (Q&A) session that allows employees to submit questions or statements to the CEO 3121. The CEO 3121 can communicate with the employee 3102, and other employees can view the communications and join the interactive discussion at 3164. Such interaction additionally allows a merger organization to retain employees, and reduces the amount of misinformation that can arise during a merger.

Panel 3125 allows the user 3102 to have a personalized merger task list. Panel 3170 allows employees to submit and view interactive polls or questionnaires. Employees can also view previous polls 3171 and Q&A sessions 3163 that have been archived.

Panel 3130 can keep employees informed of merger-related events. For example, panel 3130 displays the date 3134 and type of event 3136 related to a merger, such as a CEO breakfast event 3138 in Atlanta. The employee 3102 can select the event link of 3138 and can be further presented with a page (not shown) of information related to the breakfast. The employee can also add the event to an external calendar program, such as the calendar program in Outlook by Microsoft Corporation.

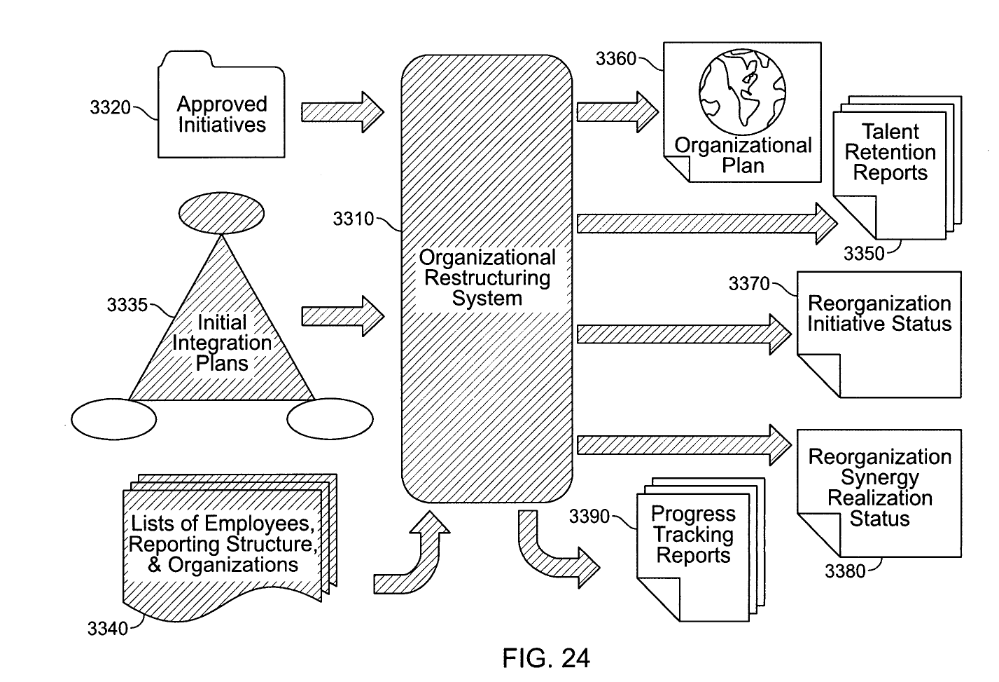

FIG. 24 illustrates a representation of an exemplary organizational restructuring system 3310 with inputs or prerequisites, and outputs or generated results. Some of the prerequisites can include one or more approved initiatives 3320, initial integration plans 3335, and lists 3340 of employees, reporting structures, and organizations. Other prerequisites (not shown) can include enterprise change information related to one or more of the following: historical data, financial information, sales information, marketing information, real estate property or lease information, or regional employment policies. Some of the generated results can include one or more organizational plans 3360, talent retention objects or reports 3350, reorganization initiative statuses 3370, reorganization synergy realization statuses 3380, and progress tracking objects or reports 3390. Some other generated results (not shown) can include enterprise change information directly or indirectly related to one or more of the following: financial objects, sales information, marketing information, distribution information, or employee-related legal objects.

Other embodiments can be within the scope of the following claims.

What is claimed is:

1. A method comprising:
providing a single logical physically distributed information system across one or more information systems of at least two enterprises, wherein the enterprises are being combined; and
providing a user interface to access the single logical information system, wherein the single logical physically distributed information system executes one or more merger activities, pre-merger activities, and post-merger activities, wherein the merger activities comprise organizational restructuring and personnel redeployment.

2. The method of claim 1, wherein the user interface is adapted to at least one of a role of the user and a phase of the merger, wherein the user role comprises an internal expert and an external expert of one of the enterprises, wherein the internal expert comprises at least one of an executive, an employee, a manager, an investor, and an owner of one of the enterprises, wherein the external expert comprises at least one of a consultant, an advisor, a supplier, an analyst, and a specialist.

3. A system for planning a merger of at least two organizations, the system comprising:
a first interface adapted to allow a user to plan a human resource project related to the merger with a resource management capability and a time management capability; and
a second interface adapted to deliver a targeted result related to the resource management capability and the time management capability wherein the second interface permits creating, posting, and sharing information related to the merger.

4. The system of claim 3, further comprising a user interface adapted for a manager of at least one of the organizations, further comprising tools adapted to allow a user to exchange merger information with a person associated with one of the organizations, wherein the person is selected from a class consisting of managers, employees, customers, partners, suppliers, consultants, analysts and specialists.

5. A system for implementing a merger of at least two organizations, wherein the system comprises a computer module adapted to allow a user to restructure at least one of the organizations, wherein the computer module comprises instructions operable to perform at least one of a planning of an organizational movement of a person, a tracking of an organizational movement of a 8 p person, a tracking of an employee from various rankings and locations within at least one organization, an assigning of a person of one of the organizations to collaborate with a user of the system, a matching of organizational resources, and a redeploying of resources of at least one organization.

6. The system of claim 5, wherein the tracking of an organizational movement of one or more employees comprises a headcount and a measure of an influence of an organizational change on one or more employees in a time period.

7. The system of claim 5, wherein the computer module generates one or more objects to track the movement of a person within at least one organization, wherein the objects comprise reports, charts, and documents.

8. A system for implementing a merger of at least two organizations, wherein the system comprises a software tool presenting a user with at least one of a personalized object, a preferred object, a recently accessed object, and a merger-related object.

9. A computer system for implementing a merger of at least two organizations, wherein the computer system comprises a first module for budget planning and a second module for headcount quota planning, wherein the module comprises a graphical user interface.

10. The computer system of claim 9, wherein the graphical user interface comprises a job description, a number of open positions, a number of filled positions, and at least one of a planning period and a time interval.

11. The computer system of claim 10, wherein the graphical user interface allows a user to add, delete, and edit positions.

12. A system for implementing a merger of at least two organizations, wherein the system comprises a computer module for headcount analysis, wherein the computer module comprises a user interface adapted to present a chart of employee headcount information for a time period.

13. The system of claim 12, wherein the system further comprises a user interface adapted to edit information for one or more personnel of at least one of the merger organizations.

14. The computer system of claim 13, wherein the user interface further comprises a link to an interface for at least one of a promotion request, an internal reassignment, a personnel transfer, a special payment request, and a change of personnel groups.

15. The computer system of claim 13, wherein the computer system further comprises an organizational planning interface, wherein the organizational planning interface comprises information personalized for at least one of the organizations and a greeting message personalized for an organizational planning interface.

16. The computer system of claim 15, wherein the organizational planning interface is adapted to facilitate a redeployment of one or more employees, wherein the organizational planning interface further comprises a panel and information for at least one of an office overview, a functional overview, a divisional overview, and a status overview of at least one of the organizations.

17. The computer system of claim 16, wherein the panel presents at least one of a number of positions, a number of assigned positions, and a number of unassigned positions, wherein the panel comprises a graph presenting a status of employee transitions and placements.

18. The computer system of claim 15, wherein the organizational planning interface further comprises information for one or more organizational headcounts pending approval, information for a financial impact, information for employee layoffs, and one or more issues for employee redeployment, wherein the one or more issues for employee redeployment comprises an indicator of a priority level for an issue, a date of creation of the issue, and a name of one or more stakeholders presenting the issue.

19. The computer system of claim 15, wherein the organizational planning interface further comprises at least one of a link presenting an employee redeployment, a link presenting an organizational personnel structure, a link presenting a headcount planner, a link presenting an employee retention tool, and a link presenting an employee compensation tool.

20. A system for implementing a merger of first and second organizations, wherein the system comprises:
a first user interface for the first organization, wherein the first user interface comprises human resource information;
a second user interface for the second organization; and
a link relating the first and second user interfaces.

21. The system of claim 20, wherein at least one of the interfaces present at least one of an organizational information, a financial statement, an organizational historical statement, a background statement, an investor information, and answers to frequently asked questions, wherein at least one of the interfaces further presents at least one of an employee headcount, a headcount category, a history of headcount transitions, a predicted headcount transition, and a menu of one or more disparate interfaces, wherein the menu comprises one or more interface links for at least one of a management plan, a transition plan, a management initiative, and a risk management overview.

22. A system for implementing a merger of at least two organizations, wherein the software product is adapted to present an interface for planning, managing, and assessing human resource information, wherein the human resource information comprises at least one of a hiring date, a benefit scale, and an indicator of employee absenteeism.

23. The system of claim 22, wherein the system permits a user to define one or more parameters for absenteeism, wherein the indicator comprises a graphical calendar emphasizing one or more days of absenteeism, wherein the human resource information further comprises a picture of one or more employees.

24. The system of claim 22, wherein the system further comprises a module adapted to track a realization of merger objectives, wherein the merger objectives comprise tangible and intangible merger objectives, wherein the intangible merger objectives comprise a product brand recognition for one or more customers and one or more cultural issues of employees of at least one of the organizations.

25. The system of claim 22, wherein the system further comprises a module adapted to track a cultural effect of organizational changes.

26. The system of claim 22, wherein the system further comprises a module adapted to track one or more interfaces between a first group of a first organization and a second group of a second organization, wherein the one or more interfaces comprises input data, output data, and information related to one or more reports.

27. An article comprising a machine-readable medium storing instructions operable to cause one or more machines to perform operations comprising:
planning a merger of at least two organizations;
managing the merger of at least two of the organizations;
restructuring an organizational structure of at least one of the organizations; and
redeploying one or more personnel in at least one of the organizations.
